(19) United States
(12) Patent Application Publication
(10) Pub. No.: US 2006/0135011 A1
(43) Pub. Date: Jun. 22, 2006

(54) Thermoplastic insulation blanket

(75) Inventors: Furio Orologio, Etobicoke (CA); John Starr, Etobicoke (CA)

Correspondence Address: MORGAN LEWIS & BOCKIUS LLP, 1111 PENNSYLVANIA AVENUE NW, WASHINGTON, DC, 20004, US

(73) Assignee: COVERTECH FABRICATING INC.

(21) Appl. No.: 11/017,759

(22) Filed: Dec. 22, 2004

(51) Int. Cl. B32B 25/02; B32B 27/12

(52) U.S. Cl. 442/37; 442/38; 442/41

(57) ABSTRACT

An improved lightweight, compact, multi-layer thermoplastic insulation blanket for thermally insulating a building structure, the blanket comprising a laminate of a first thermoplastic layer; a second thermoplastic layer; a thermoplastic bubble layer; and a third thermoplastic layer, the improvement comprising a scrim laminated to the first and second layers as to be visible through the first layer. The blanket provides an aesthetically-pleasing visible appearance to employees and shoppers in retail and bulk-warehouse buildings without the need for non-thermoplastic materials, such as fibreglass or like insulation materials.

### FIELD OF THE INVENTION

This invention relates to thermal insulation blankets comprising laminated thermoplastic layers for use in building structures, particularly, metal buildings, such as barns, and retail/warehouse structures.

### BACKGROUND OF THE INVENTION

In the trend to have large retail shops in the form of “box-warehouse” structures where the goods on sale are viewed by public purchasers, shoppers and the like, aesthetic pleasing surroundings, particularly, for open-viewed ceilings of reduced capital cost, are desired by the wholesaler/retailer. Also, it is also known that good insulation that reduces heat gain or loss and improves animal comfort can increase animal productivity and reduce animal mortality.

Thermal insulation blankets comprising laminates of layers of thermoplastic materials, such as, for example, polyethylene sheets and bubble-packs, are used extensively as insulation in such buildings, particularly, metal structures.

Also used in such structures are thermal blankets comprising thermoplastic laminates having a scrim layer to provide additional strength, which laminates are used in conjunction with additional layers of fibreglass and or other non-thermoplastic insulation materials. However, while such fibreglass materials offer well-known advantages as insulation materials, in their use in the aforesaid box warehouse buildings, they suffer from significant, including seasonal, disadvantages. For example, although a thickness of 0.5 cm may be effective in certain circumstances, the fibreglass is generally used at a significant thickness of between 2.5 cm-15 cm. Further, while not only presenting moisture-condensation problems, particularly, in cooler climates, it also provides a nesting habitat for rodents and birds. Thus, precautions against health hazards during'installation and subsequently, must be taken. Yet further, the viewing of the fibreglass in the aforesaid “open-ceiling” structure may not be conducive to the image the store owner wishes to portray.

There is, therefore, a need for a thermal insulation blanket for use in the aforesaid buildings, which does not suffer from the aforesaid disadvantages, while providing satisfactory thermal insulation values, strength and visual appearance.

### SUMMARY OF THE INVENTION

It is an object of the present invention to provide an aesthetically-pleasing thermal insulation blanket for use in building structures, particularly, those with open ceilings visible to employees and the public, and having satisfactory strength and insulative properties, without the need for non-thermoplastic materials, such as fibreglass or like insulation materials.

Accordingly, in one aspect, the invention provides an improved lightweight, compact, multi-layer thermoplastic insulation blanket for thermally insulating a building structure, said blanket comprising a laminate of a first layer;

a second layer;

a bubble layer; and

a third layer;

the improvement comprising a scrim laminated to said first and second layers as to be visible through said first layer.

By the term “scrim” in this specification and claims is meant a mesh or net-like arrangement of longitudinal and transverse members formed of a strengthening material, such as a thermoplastic material or metal strand or fibre, woven or laminated to or embedded in a thermoplastic material. The presence of the scrim provides strength and reduces the a mount of tearing or breaking (running) of the laminate.

By the term “bubble” and “bubble-pack” is meant a plurality of longitudinally and transversely spaced discrete semi-spherical sealed air encapsulated pockets as is well-known in the art.

Preferably, each of the layers is made of a material selected from the group consisting of polyethylene, polypropylene and polyvinylchloride.

Preferably, the layers are formed of polyethylene.

In alternative embodiments the first and/or second layers is a metallized thermoplastic layer or is laminated to a metal foil, preferably, aluminum.

The absolute and relative thickness of each of the layers in the laminate and the resultant cumulative laminated blanket may be readily determined by the person skilled in the art.

It is an essential feature of the present invention that the “scrim” appearance be visible.

In a further aspect, the invention provides a building structure provided with thermal insulation comprising an insulation blanket as, hereinabove, defined.

### BRIEF DESCRIPTION OF THE DRAWINGS

In order that the invention may be better understood, preferred embodiments will now be described, by way of example only, with reference to the accompanying drawings, wherein

FIGS. 1 and 2 are diagrammatic, exploded sectional views of bubble-pack laminated insulation blankets, according to the prior art;

FIG. 3 is a diagrammatic, sectional view of a laminated scrim insulation blanket according to the prior art;

FIGS. 4, 5 and 6 are diagrammatic, exploded views of bubble-pack, scrim laminated insulation blankets according to the invention;

FIG. 7 is a diagrammatic, isometric view of the combined bubble-pack-scrim laminated insulation blanket of FIG. 4 after lamination, when viewed in the direction shown by arrow A;

FIG. 8 is a diagrammatic, isometric view of a building having roof insulation provided by a thermal blanket of FIG. 7; and wherein the same numerals denote like parts.

### DETAILED DESCRIPTION OF PREFERRED EMBODIMENTS

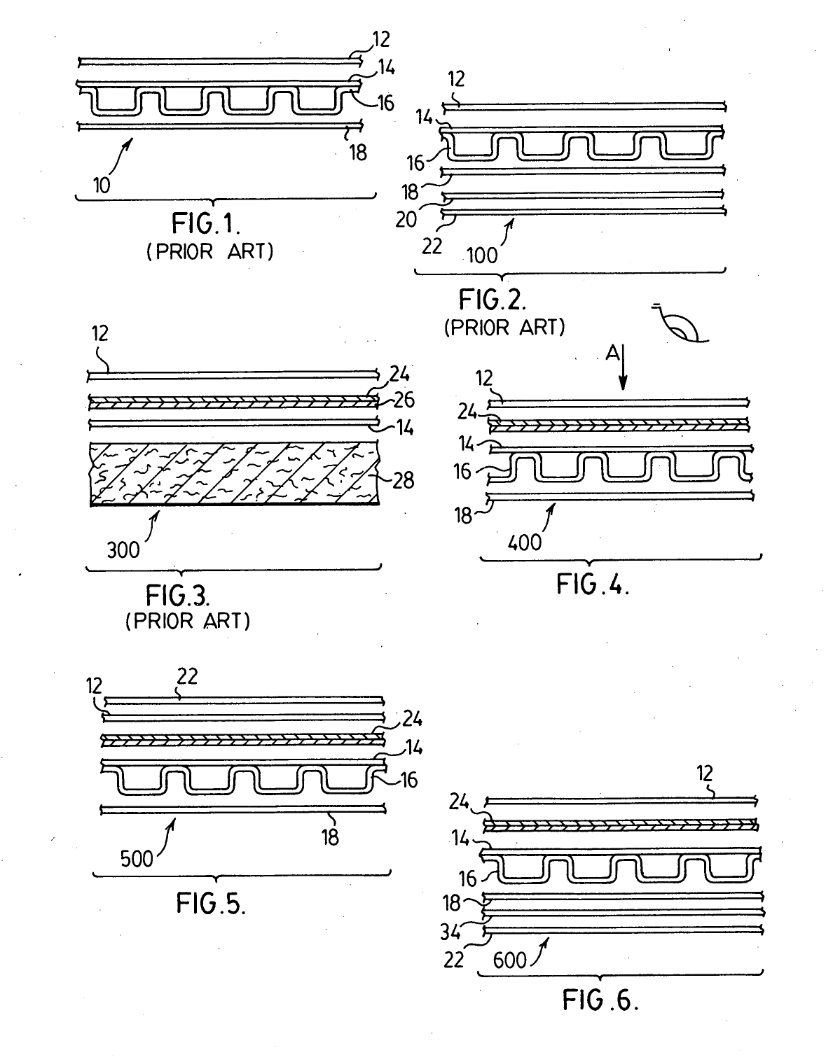

With reference to FIG. 1, this shows generally as 10, a bubble-pack laminated blanket having a polyethylene first layer 12, a polyethylene second layer 14, a polyethylene bubble layer 16 and a polyethylene third layer 18, wherein the layers are shown in an exploded view as discrete entities, for ease of understanding.

FIG. 2 shows generally as 100, the embodiment of FIG. 2 to which is also laminated a polyethylene layer 20 and aluminum foil 22.

FIG. 3 shows generally as 300, a laminated scrim blanket having first layer 12 and second layer 14, and, therebetween, nylon transverse and longitudinal members 24 embedded in scrim 26. A fibreglass layer of 5 cm thickness is adhered to layer 14.

FIG. 4 shows generally as 400, a bubble-pack-scrim laminated blanket having polyethylene layers 12, 14, 16 and 18, as described with reference to FIG. 1, but having scrim layer 26 with nylon tapes 24, laminated between layers 12 and 14.

FIGS. 5 and 6 show generally as 500 and 600, respectively, the embodiment of FIG. 4, but, additionally, having an aluminum foil layer 22, laminated to layer 12 in FIG. 5 and to layer 18, via a polyethylene layer 34, in FIG. 6.

The bubble-pack layer is preferably of a thickness selected from 0.5 cm to 1.25 cm. The other polyethylene layers are each of a thickness, preferably, selected from 1 to 6 mls.

FIG. 7 shows generally as 700, an isometric view of the embodiment of FIG. 4 as viewed by eye 30 in the direction of arrow A. Although beneath layer 12, the nylon tapes 24 are pleasingly visible.

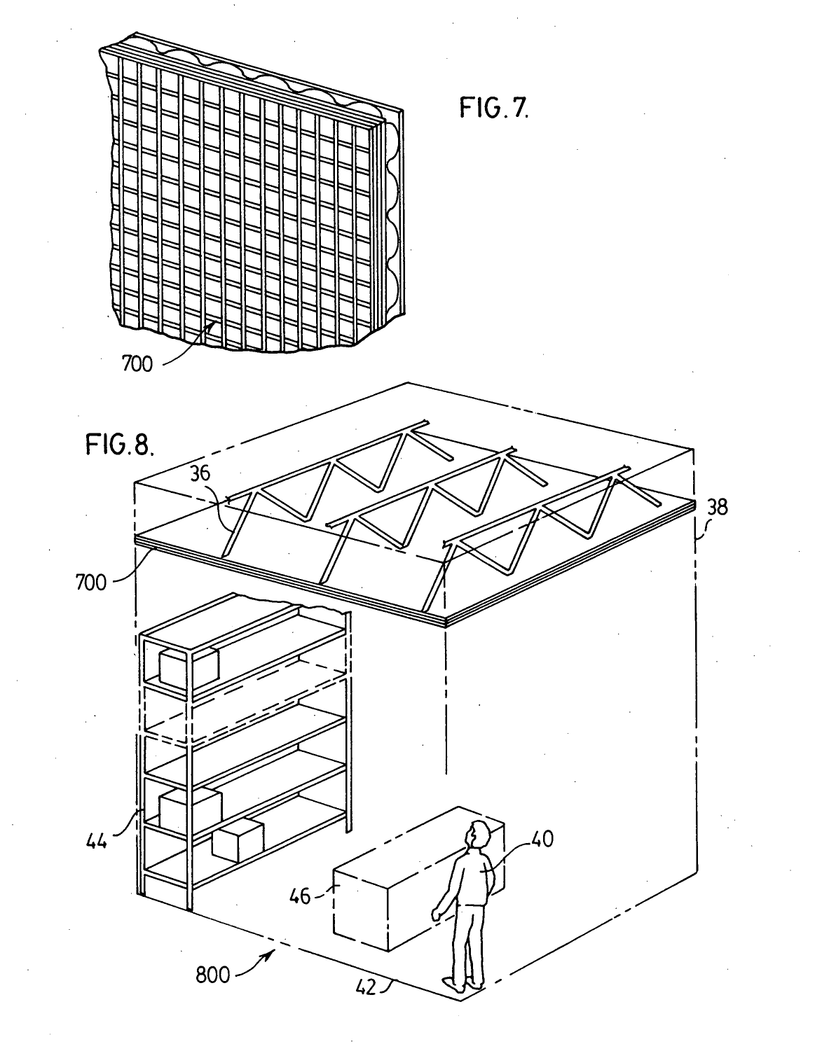

FIG. 8 shows generally as 800, a thermal insulation blanket 700, according to the invention, located between roof struts and supports 36 of an open-ceiling warehouse building 38. Blanket 400 is disposed such that scrim 24 is viewable by shopper 40 walking on floor 42 between wall shelves 44 and display cabinets 46.

It would be understood by the person skilled in the art that additional layers may be present in the blankets as hereinabove defined depending on the degree of insulation desired or on a cost-effective basis.

The laminated blankets according to the invention may be readily manufactured by processes well-known in the art, for example, as described, in part, in U.S. Pat. No. 6,514,596 B1, issued Feb. 4, 2003 to Orologio, Furio.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

We claim:

1. An improved lightweight, compact, multi-layer thermoplastic insulation blanket for thermally insulating a building structure, said blanket comprising a laminate of
a first thermoplastic layer;
a second thermoplastic layer;
a thermoplastic bubble layer; and
a third thermoplastic layer;
the improvement comprising a scrim laminated to said first and second layers as to be visible through said first layer.

2. A material as defined in claim 1 wherein each of said layers is made of a material selected from the group consisting of polyethylene, polypropylene and polyvinylchloride.

3. A material as defined in claim 1 wherein said layer selected from the group consisting of said first layer and said third layer is laminated to a metallic foil.

4. A material as defined in claim 2 wherein said layer selected from the group consisting of said first layer and said third layer is laminated to a metallic foil.

5. A material as defined in claim 1 wherein each of said thermoplastic layers is formed of polyethylene.

6. A material as defined in claim 2 wherein each of said thermoplastic layers is formed of polyethylene.

7. A material as defined in claim 3 wherein each of said thermoplastic layers is formed of polyethylene.

8. A building structure provided with a thermal insulation blanket as defined in claim 1.

9. A building structure provided with a thermal insulation blanket as defined in claim 2.

10. A building structure provided with a thermal insulation blanket as defined in claim 3.

11. A building structure provided with a thermal insulation blanket as defined in claim 4.

12. A building structure provided with a thermal insulation blanket as defined in claim 5.

13. A building structure provided with a thermal insulation blanket as defined in claim 6.

14. A building structure provided with a thermal insulation blanket as defined in claim 7.
